(19) United States
(12) Patent Application Publication
(10) Pub. No.: US 2013/0220899 A1
(43) Pub. Date: Aug. 29, 2013

(54) FILTER CARTRIDGE MONITOR

(71) Applicants: Shin-Wei Lin, Linkou (TW); Sheng-Nan Lin, Pingtung City (TW)

(72) Inventors: Shin-Wei Lin, Linkou (TW); Sheng-Nan Lin, Pingtung City (TW)

(73) Assignee: 3M INNOVATIVE PROPERTIES COMPANY, ST.PAUL, MN (US)

(21) Appl. No.: 13/642,431

(22) PCT Filed: Apr. 21, 2011
(86) PCT No.: PCT/US11/33412

§ 371 Date: May 2, 2013

(30) Foreign Application Priority Data
Apr. 21, 2010 (CN) 201010167414.5

(51) Int. Cl. B01D 27/10

(52) U.S. Cl. CPC B01D 27/101
USPC 210/85

(57) ABSTRACT

A filter cartridge monitor (1) includes a body (2), a shaft (3) extending downward from the body, a circuit board (23) installed in the body (2), an indicator (21) electronically connected to the circuit board (23), a floating component (4) that can move along the shaft (3), and at least one sensor (31) installed on the shaft (3) that is electronically connected to the circuit board (23). When water is poured into the inner jug (52), the floating component (4) will float and move due to its buoyancy in the water. The movement of the floating component (4) can be regarded as the volume of water that passes through the filter cartridge (53), which can be recorded by the circuit board (23) of the monitor (1).

### BACKGROUND

The present invention relates to a fluid filter monitor and, more particularly, a fluid filter monitor used to monitor the usage life of a filter cartridge in a fluid filter.

Tap water in homes is often supplied from water towers, and if the water towers are not cleaned regularly, the tap water may contain foreign materials such as sand, bacteria, algae, and heavy metals. If the tap water does not undergo proper treatment or filtering procedures, the water may have negative effects on personal health after long-term drinking. In order to satisfy the need for filtering tap water used in the home, people in the past mostly used an entire set of filtering equipment. Such equipment, however, is not easy to install, and the costs are high.

Another approach to filter tap water in the home is to use fluid filters, such as water pitchers or jug filters, that take up little space and are easy to install and use to filter water, especially drinking water.

When conventional fluid filters are used for a period of time, the filter cartridge must be replaced. Current monitors used to monitor the life of filter cartridges on the market today use only the length of installation time of the filter cartridge as their basis for whether or not to replace the filter cartridge. As a result, they cannot precisely determine the volume of water that is filtered by the filter cartridge, nor accurately measure the usage life of the filter cartridge. This being the case, if a low volume of water is used by the fluid filter and the filter cartridge still has considerable filtering ability, but the monitor still relies on the predetermined time to notify the user to replace the filter cartridge, this will cause unnecessary waste. Conversely, if a high volume of water is used by the fluid filter and the filter cartridge has used up its filtering ability, but the monitor does not notify the user to replace the filter cartridge because the predetermined time has not expired, this will cause the user to mistakenly use unfiltered water.

Filter cartridge life monitors are known in the patented prior art. U.S. Pat. No. 6,224,751, for example, discloses a water purifying device with means for indicating exhaustion of the purifying medium. As shown in FIG. 1, which is the filter cartridge life monitor 7 of U.S. Pat. No. 6,224,751 is installed on the lid 61 of the fluid filter 6, and the monitor 7 and its display screen 71 can be viewed from above the fluid filter 6. After the user replaces the filter cartridge, the filter cartridge life monitor 7 can be activated, and the monitor 7 will start calculating the usage life of the filter cartridge, and display on the display screen 71 the remaining time until the predetermined time to replace the filter cartridge to remind the user to replace the filter cartridge. Thus, the monitor 7 disclosed in U.S. Pat. No. 6,224,751 can only measure the usage life of the filter cartridge based on the usage time of the filter cartridge, and cannot precisely know the volume of water filtered by the filter cartridge, nor accurately determine the life of the filter cartridge. As mentioned above, such an inaccurate method of estimating the usage life of the filter cartridge will often cause the filter cartridge to be replaced and discarded while it still is an effective filter, or cause the filter cartridge to continue to be used after it is no longer an effective filter.

### SUMMARY

As such, the need exists for a filter cartridge monitor that can accurately determine the volume of water filtered by the filter cartridge, and thereby accurately determine the life of the filter cartridge, and notify the user of the correct time to replace the filter cartridge.

In one embodiment, the present invention provides a filter cartridge monitor that can accurately calculate and measure the volume of water filtered by the filtered cartridge.

In one aspect, the invention provides a filter cartridge monitor that can accurately determine the usage life of the filter cartridge and notify the user to replace the filter cartridge at the correct time.

In another aspect, the invention provides a filter cartridge monitor that can better exhaust the usage life of the filter cartridge to reduce unnecessary waste.

In another aspect, the invention provides a filter cartridge monitor that can prevent users from mistakenly using filter cartridges that can no longer effectively filter, thereby avoiding using unfiltered water.

In order to realize the aforementioned features and benefits, the present invention provides a filter cartridge monitor comprising a body, a shaft that extends downward from the body, a circuit board installed in the body, an indicator that is electronically connected to the circuit board, a floating component that can move along the shaft, and at least one sensor that is used to monitor the movement of the floating component, wherein the at least one sensor is installed along the shaft and electronically connected with the circuit board.

In another embodiment, the present invention provides a fluid filter comprising an outer jug with an open top and outlet, an inner jug that fits into the open top of the outer jug and has an inlet in its top, a filter cartridge that joins and connects with the inner jug, the aforementioned monitor installed in the inner jug and having a shaft that extends to the inner part of the inner jug, an indicator that can be seen from outside the fluid filter, and a power source that is electronically connected to the circuit board.

The following drawings and detailed description of the preferred embodiments are hereby provided so that those skilled in the art may better understand the technical features of the invention and as a basis for realizing the embodiments. The description is only used to describe the preferred embodiments of the invention, and is not limited to any form of the invention, and any revisions or changes made in the spirit of the invention shall fall within the scope claimed by the invention.

### BRIEF DESCRIPTION OF THE DRAWINGS

FIG. 1 is a filter cartridge life monitor according to the prior art;

FIG. 2 is a three-dimensional drawing of the filter cartridge monitor according to the present invention;

FIG. 3 is a cross-section of the filter cartridge monitor of the present invention;

FIG. 4 is a cross-section of the filter cartridge monitor of the present invention combined with the fluid filter inner jug;

FIG. 5 is a schematic drawing of the filter cartridge monitor of the present invention combined with the fluid filter; and

FIG. 6 is a process flowchart showing the operation of the filter cartridge monitor of the present invention.

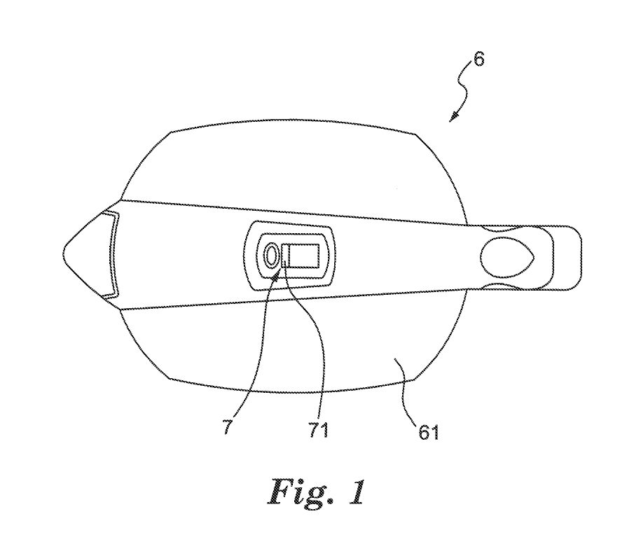

### DETAILED DESCRIPTION

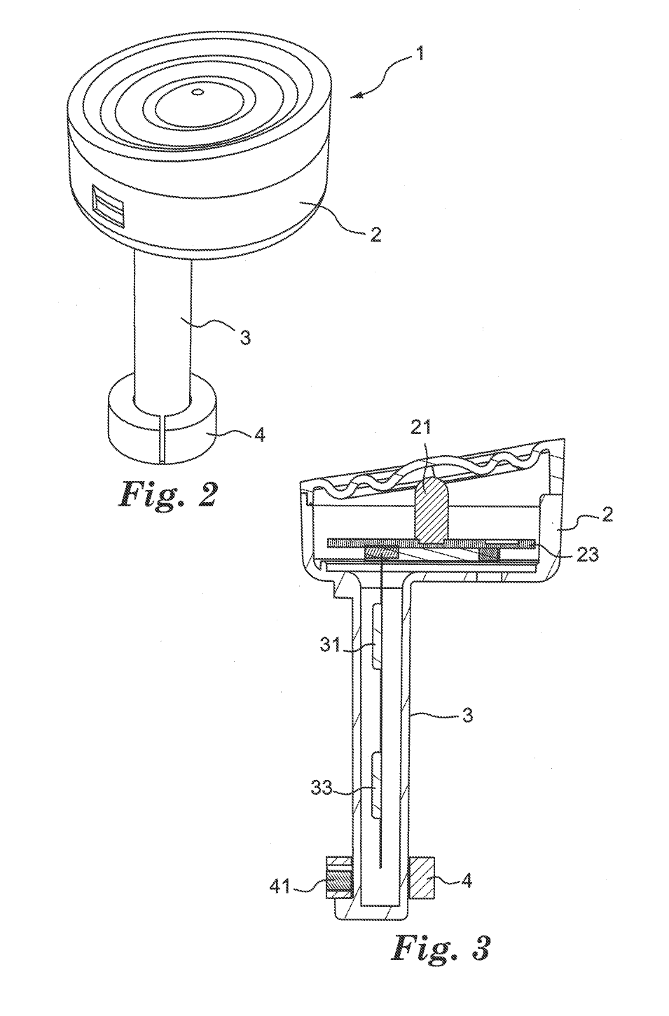

As shown illustrated in FIG. 2 and FIG. 3, a cartridge monitor 1 generally includes a body 2, a shaft 3, an indicator 21, a circuit board 23, two sensors 31, 33, and a floating component 4.

In the illustrated embodiment, the indicator 21 is installed on the body 2, particularly on the inner part of the body, and the indicator 21 is an LED (Light Emitting Diode) light and the body 2 is generally cylindrical or tube-shaped. In other embodiments, the indicator 21 may be separated from the body 2. The indicator 21 may also be installed on an LCD (liquid crystal display) display (not shown) on the body 2. The circuit board 23 is located within the body 2, and is electronically connected to the indicator 21. The shaft 3 is formed below the body 2, and mostly extends vertically downward from the body 2. In the illustrated embodiment, the floating component 4 is annular or ring-shaped and is installed around the shaft 3. Arranged in this manner, the floating component 4 can move along the direction of the extended shaft 3. In the present embodiment, the floating component 4 can be a floating member.

In the illustrated embodiment, two sensors 31, 33 are used to detect the movement of the floating component 4. The sensors 31, 33 are installed on the shaft 3, or preferentially installed within the shaft 3, and are electronically connected with the circuit board 23 in the body 2. The two sensors 31, 33 are separated from one another by a certain distance, and sensor 31 can be installed near the base of the body 2, while the sensor 33 can be installed near the base of the shaft 3. In the illustrated embodiment, the sensors 31, 33 are magnetic reed switches, but can also be, for example, Hall effect sensing elements, and a magnet 41 can be installed in the floating component 4. Furthermore, the body 2 contains a place to install a power source (not shown), and this place can be installed with a power source (such as mercury button batteries) to provide a power source to operate the monitor 1.

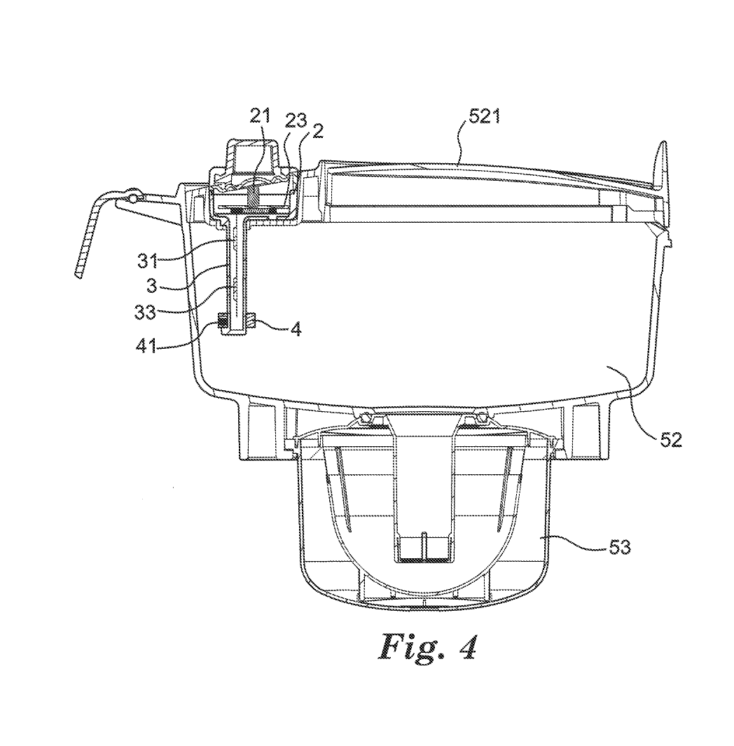

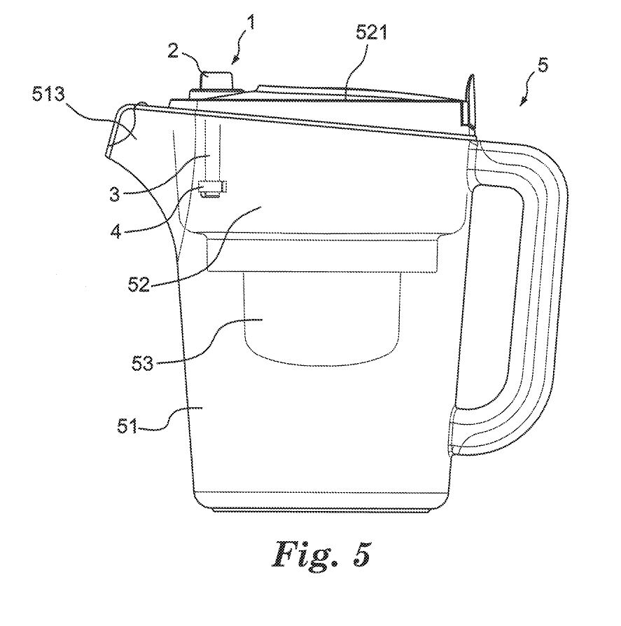

FIG. 4 and FIG. 5 show the combination of the filter cartridge monitor 1 and the fluid filter 5 in the present invention, in particular the combination of the fluid filter 5 and the inner jug 52. The fluid filter 5 has an outer jug 51, an inner jug 52, and a filter cartridge 53. The top of the outer jug 51 is an open top, the inner jug 52 is installed on the top of the outer jug 51 and fits into the open top of the outer jug 51, and the water-containing body of the inner jug 52 is installed within the outer jug 51. Filter cartridge 53 is installed in the inner part of the outer jug 51 of fluid filter 5, and combines with the bottom side of the inner jug 52. The user can pour water to be filtered into inner jug 52 from the inlet 521 of the inner jug 52, and the water poured into the inner jug 52 then flows into filter cartridge 53. The water flows into the outer jug 51 after being filtered by the filter cartridge by passing through filter cartridge 53. When the user wishes to use the water filtered in fluid filter 5, the water filtered by filter cartridge 53 and stored in the outer jug 51 can be poured from the outlet 513 of the outer jug 51.

The filter cartridge monitor 1 is installed at the top end of the inner jug 52, and its shaft 3 extends into the inner jug 52 to monitor the usage life of filter cartridge 53 combined with the inner jug 52. In the illustrated embodiment, body 2 of monitor 2 can be exposed on the top surface of the inner jug 52, so that monitor 1 indicator 21 can be seen from outside fluid filter 5.

When the user pours water into the inner jug 52 through inlet 521, the floating component 4 installed on monitor 1 shaft 3 will move upward along the shaft 3 from the bottom of the shaft 3 due to its buoyancy in the incoming water, and at the same time, the two sensors 31, 33 installed on the shaft 3 will be started by the movement of floating component 4. Because the two sensors 31, 33 are magnetic switches (or Hall components) and are installed on the shaft 3 at a certain distance from one another, and the floating component 4 has a magnet 41, the incoming water will cause the floating component 4 to float up from the base of the shaft 3, and when it passes by sensor 3 located near the bottom of the shaft 3, the magnet 41 in the floating component 4 will activate the magnetic reed switch of the sensor 33, and the sensor 33 will send a signal to the circuit board 23 embedded in the body 2. Furthermore, when the incoming water causes the floating component 4 to float upward past the sensor 31 located near the bottom of the body 2, the magnet 41 in the floating component 4 will also activate the magnetic reed switch of the sensor 31, and sensor 31 will send a signal to the circuit board 23 embedded in body 2.

The sensors 31, 33 can be set to detect a certain fixed volume of water already poured into the inner jug 52 based on their positions on the shaft 3. If the sensor 33 is set to detect the volume of water poured into the inner jug 52 at 70% of the total water volume, when incoming water causes the floating component 4 to float up from the bottom of the shaft 3 and pass by the sensor 33, the magnet 41 in the floating component 4 will activate the magnetic reed switch of the sensor 33, and the sensor 33 will send a signal to the circuit board 23 embedded in the body 2 to tell it that the volume of water poured into the inner jug 52 is 70% of the total water volume of the inner jug 52.

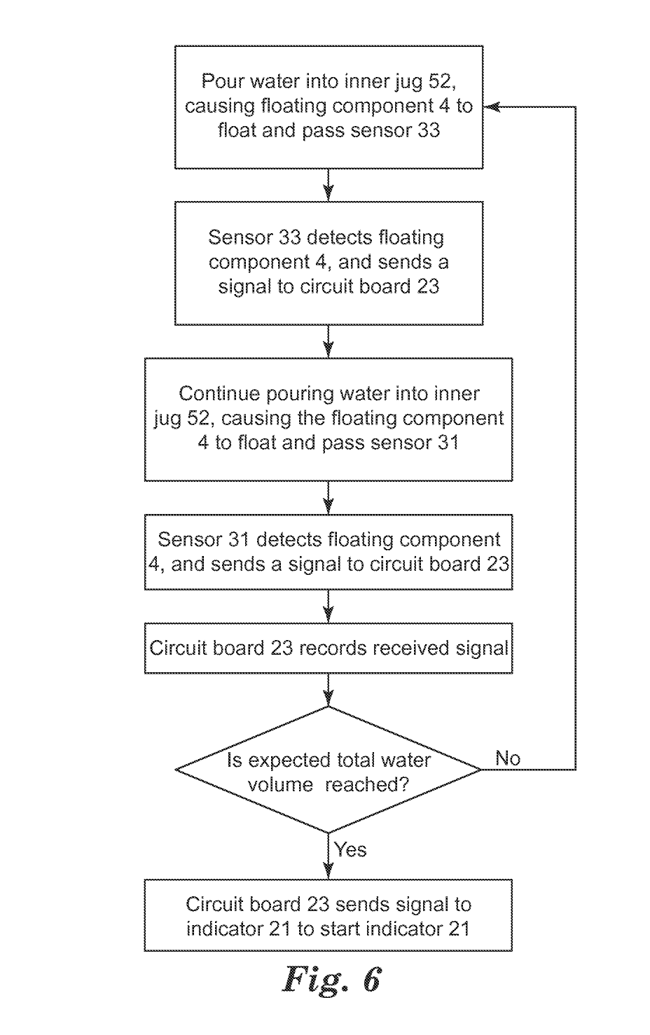

If sensor 31 is set to detect the volume of water poured into the inner jug 52 at 100% of the total water volume, when incoming water causes the floating component 4 to float up from the bottom of the shaft 3 and pass by the sensor 31, the magnet 41 in the floating component 4 will activate the magnetic reed switch of the sensor 31, and the sensor 31 will send a signal to the circuit board 23 embedded in the body 2 to tell it that the volume of water poured into the inner jug 52 is 70% of the total water volume of the inner jug 52 (as shown in FIG. 6). Repeatedly using the fluid filter 5 in this way, monitor 1 will re-record the volume of water that flows into fluid filter 5 from the filter cartridge 53, and when the total water volume used by fluid filter 5 reaches the predetermined total water volume, the circuit board 23 in the body 2 will send a signal to the indicator 21, causing the indicator 21 to emit a reminder notifying the user that the usage life of the filter cartridge 53 has expired (or is about to expire), and that the filter cartridge should be replaced (as shown in FIG. 6).

If the indicator 21 is an LED light, when the usage life of the filter cartridge 53 has expired, the LED light will light up to notify the user; or different colored LED lights can be used so that before the usage life of the filter cartridge 53 expires the user is notified by one color, and after the usage life of the filter cartridge 53 expires, the user is notified by another color. If the indicator 21 is an LCD screen, when the usage life of the filter cartridge 53 has expired, the LCD screen will display a reminder image to notify the user, or when the circuit board 23 calculates and records the water volume, the LCD can simultaneously and continuously display the remaining usage life of the filter cartridge 53 on the LCD screen to notify the user. Furthermore, monitor 1 may optionally include a reset button (not shown), and after the user replaces the filter cartridge, the user can manually press the reset button to reset the circuit board 23 of monitor 1 to start again recording the volume of water that passes through the new filter cartridge.

In another embodiment, monitor 1 is not installed with a reset button, and if the floating component 4 or an external magnet (not shown) passes quickly by the two sensors 31, 33 along the shaft 3, and the time in which the sensors 31, 33 are passed by is shorter than the usual time in which floating component 4 passes by sensors 31, 33 when water is poured into the inner jug 52 causing the water level of the inner jug 52 to rise, this will cause the two sensors 31, 33 to rapidly and successively send two signals to the circuit board 23, and after the circuit board 23 respectively receives the two signals sent rapidly and successively from the two sensors 31, 33, it will use a reset action to reset and start recording again the volume of water that passes through the new filter cartridge.

Furthermore, monitor 1 may be given a fool-proof design. If a sensor (such as sensor 31) used to detect a larger volume of water poured into the inner jug first detects the floating component 4, then the sensor (such as sensor 33) used to detect a smaller volume of water poured into the inner jug detects the floating component 4, then the detected signal will not be recorded by the circuit board 23, and in this way, when water poured into the inner jug 52 passes through the filter cartridge 52 and flows into the outer jug 51, the signal generated by the decreasing water level of the inner jug 52 causing floating component 4 to activate the sensors will not be mistakenly recorded by the circuit board 23. Furthermore, if a single sensor is rapidly activated twice by the floating component 4 (i.e., shorter than the usual time when water poured into the inner jug 52 causes the water level of the inner jug 52 to rise, then the water is poured out, causing the floating component 4 to pass by the sensor 31 twice or pass by the sensor 33 twice), then the two signals generated by the aforementioned two activations will not be recorded by the circuit board 23, and this can prevent the two signals generated by shaking caused by the user moving the fluid filter 5, which causes the floating component 4 to move up and down along the shaft 3 due to the shaking, thereby rapidly activating the sensor twice from being mistakenly recorded by the circuit board 23.

In the aforementioned embodiments, only water passing by the sensors 31, 33 shall count as one water volume measurement, but the shaft 3 of monitor 1 may only be given one monitor, and does not need two monitors. A single monitor may be configured as the monitor to detect a certain fixed volume of water poured into the inner jug 52 based on the location where the monitor is set, and if the sensor is installed on the shaft 3 near the bottom of the body 2, like the aforementioned sensor 31, the sensor 31 can be set at 80% of the maximum water volume for the volume of water poured into the inner jug 52 that it can detect, and when incoming water causes the floating component to float up from the base of the shaft 3 and pass by the sensor 31, the magnet 41 in floating component 4 will activate the magnetic reed switch in the sensor 31, and the sensor 31 will send a signal to the circuit board 23 embedded in the body 2 to notify it that the volume of water poured into the inner jug 52 is 80% of the maximum water volume of the inner jug 52.

The aforementioned embodiments can also be slightly revised in the spirit of the invention. For example, the monitors may have different appearances. Also, the sensors used to detect movement of the floating component may have different applications, or the number and position of the sensors on shaft 3 and position of the indicator may be changed, but minor corrections made in the spirit of the present invention may not depart from the spirit and major features of the present invention. Therefore, all aspects of the above embodiments shall be regarded as illustrative and not as restrictive, and all changes that conform to the meaning and scope of the claims or that are equally valid, shall be included within the scope of the present invention.

1. A monitor (1) used to monitor the volume of water that passes through the filter cartridge, comprising:
body (2);
shaft (3), extending downward from the body (2);
a circuit board (23) installed in the body (2);
an indicator (21) electronically connected to the circuit board (23);
a floating component (4) movably arranged along the shaft (3); and
at least one sensor used to monitor the movement of the moving component (4) installed along the shaft (3) and electronically connected to the circuit board (23).

2. A monitor (1) according to claim 1, wherein the body (2) is a cylindrical and the indicator (21) is an LED light.

3. A monitor (1) according to claim 1, wherein the indicator (21) is an LCD display, and when the monitor (1) detects that a predetermined volume of water has passed through the filter cartridge, the LCD display reminds the user to replace the filter cartridge.

4. A monitor (1) according to claim 1, wherein the indicator (21) is an LCD display, and the indicator (21) continually displays the remaining life of the filter cartridge.

5. A monitor (1) according to claim 1, further comprising a reset button, and when the filter cartridge is replaced, the user can use the reset button to manually reset the monitor (1).

6. A monitor (1) according to claim 1, wherein the shaft (3) vertically extends from the base of the body (2).

7. A monitor (1) according to claim 1, wherein the floating component (4) is a floating ball.

8. A monitor (1) according to claim 1, wherein the sensor (31) is a magnetic reed switch, and a magnet (41) is embedded in the floating component (4).

9. A monitor (1) according to claim 1, wherein the sensor (31) is a Hall component, and a magnet (41) is embedded in the floating component (4).

10. A monitor (1) according to claim 1, wherein the shaft (3) is provided with two sensors (31, 33), and the two sensors are arranged a certain distance from one another along the shaft (3) and are respectively electrically connected to the circuit board (23), and one (31) of the two sensors (31, 33) is installed above the other sensor (33).

11. A monitor (1) according to claim 10, wherein one (31) of the two sensors (31, 33) is installed near the base of the body (2), and the other (33) is installed near the base of the shaft (3).

12. A monitor (1) according to claim 10, wherein the sensors (31, 33) are magnetic reed switches, and a magnet (41) is embedded in the floating component (4).

13. A monitor (1) according to claim 10, wherein the sensors (31, 33) are Hall components, and a magnet (41) is embedded in the floating component (4).

14. A monitor (1) according to claim 1, wherein the monitor (1) is designed so that when the floating component (4) rapidly passes by the sensor (31) twice, the two generated signals will not be recorded by the circuit board (23).

15. A monitor (1) according to claim 10, wherein the monitor (1) is designed so that when the floating component (4) first passes by the top sensor (31) then passes by the bottom sensor (33), the signals detected by the two sensors (31, 33) will not be recorded by the circuit board (33).

16. A monitor (1) according to claim 10, wherein the monitor (1) is designed so that when the floating component (4) rapidly passes by one of the sensors (31, 33) twice, the two generated signals will not be recorded by the circuit board (23).

17. A monitor (1) according to claim 10, wherein the monitor (1) is designed so that when the floating component (4) rapidly passes by the two sensors (31, 33), the two signals detected by the two sensors (31, 33) can cause the monitor (1) to reset.

18. A fluid filter (5), comprising:
an outer jug (51), the outer jug (51) having an open top and an outlet (513);
an inner jug (52) configured to fit the open top of the outer jug (51), the inner jug (52) having an inlet (521) in its top;
a filter cartridge (53) configured to combine and connect with the inner jug (52);
a monitor according to any of claims 1 to 17 is installed on the inner jug (52), with a shaft (3) that extends to the inner portion of the inner jug, and an indicator (21) that can be seen from outside the fluid filter (5); and
s power source electronically connected with the monitor (1).
